(19) United States
(12) Patent Application Publication
(10) Pub. No.: US 2012/0036686 A1
(43) Pub. Date: Feb. 16, 2012

(54) Device to create a space divider or spatial delimitation

(75) Inventor: Colin Schaelli, Zurich (CH)

(73) Assignee: REGROUP AG

(21) Appl. No.: 13/257,559

(22) PCT Filed: Mar. 9, 2010
(86) PCT No.: PCT/CH2010/000064

§ 371 Date: Sep. 19, 2011

(30) Foreign Application Priority Data
Mar. 20, 2009 (CH) 429/09

(51) Int. Cl. F16B 2/20; A47B 97/00

(52) U.S. Cl. 24/455; 16/404

(57) ABSTRACT

The invention concerns a unit to create a space divider. This comprises a partial base to create the space divider and a lever arm attached to the partial base. Two of the units can be combined into a single combined base, on the same level, comprising two partial bases, the lever arms of the units being attachable to the partial base of the other unit using an attachment device created by the lever arm and the partial base themselves, and the two partial bases of the two units can be linked together by means of at least one of the following elements: interlocking forms, friction and traction. The invention also relates to a shelving system using a number of the units.

This patent application is a U.S. National Stage of International Application No. PCT/CH2010/000064, filed Mar. 9, 2010.

The invention concerns a unit to create a space divider or spatial delimitation.

Devices to create space dividers or spatial delimitations already exist. These can use comprise various materials, for example cardboard or plastic. For example, stackable small load carriers are designed to contain components. And other arrangements are known, made up of different forms of components which can be combined to create a space divider, such as a shelving unit. Here, for example, rubber rings can be used to attach the individual components to each other.

The purpose of the invention is to enable an improved space divider, particularly by reducing the number of different parts required and/or by enabling simpler construction/dismantling.

This purpose is achieved by means of a unit used to create a space divider, in which two of the said units are combined into a single combined base on a single level, comprising two partial bases, the lever arms of the units being attachable to the partial base of the other unit using an attachment device created by the lever arms and the partial bases themselves, and the two partial bases of the two units can be linked together by means of at least one of the following elements: interlocking forms, friction and traction. The benefit being that from two of the units the total base can be created without use of any other means of fixing. By means of the fixing device created by two of the units themselves, a complete unit can be created from two units, thus forming a complete base. The benefit being that, due to the interlocking forms, friction and/or traction or alternatively the positioning together of the two partial bases using interlocking forms, friction and/or traction, the bases do not move in relation to each other. This holds true when total base has goods loaded onto it and even when only one of the partial bases is loaded. The benefit is that by means of the arrangement using interlocking forms, friction and/or traction, any load which is applied can also be spread to the other partial base. It is preferable that the individual units combined to form the single unit are constructed identically, such that each of the partial bases represents 50% of the total unit base. It is further preferred that at least the functional elements such as, for example, the built-in fixing devices or the partial units required for this are identical. It can, however, be envisaged that, for example, the individual units could vary in optical appearance and/or coloring. In addition, it can be envisaged that the two combinable units are shaped differently, for example having differently sized partial bases, for example in the ratios 2/3:1/3 which are combined to form the complete unit base. Two units can be understood specifically to mean that they are absolutely identical, but can also be understood to mean that the two combinable units are functionally identical or similar, whilst other features such as their dimensions or optical and/or non-functionally relevant features may differ. The combination of the two units—in particular the partial bases—to each other, using interlocking forms, friction and/or traction can be realized using suitable snap-in locking devices, clip devices and/or friction devices, which provide the benefit that the two individual units can be fixed together in a manner that provides sufficient connective force to support against whatever forces might arise when handling the total unit without breaking the connection between the combined units. This has the benefit of ensuring that the attachment or the combination will not be broken and/or slip during handling. It is preferable if the units are capable of remaining fixed together utilizing only form snap-in locking devices, clip devices and/or friction devices, or that these are present or are provided in a fixed form, and without further accessories to provide support.

In a preferred embodiment of the unit it is provided that the lever arm represents a side wall perpendicular to the partial base for the creation of the space divider. The benefit is that the units can be combined into a U-shaped element, in which, for example, items can be placed for storage.

The purpose is also achieved by a shelving system with a number of units to create space dividers, using one of the above forms of embodiment and a number of clips to link the units together. The two units can be fixed as described above, with the benefit that these can then be handled in a simple way. To achieve additional stability, it is preferable if clips are used in addition for fastening.

In an embodiment of the shelving system it is intended that the lever arm of a first unit of many is linked to the partial base of a second unit of many, and the lever arm of a second unit of many is linked to the partial base of the first unit of many, using the first type of U-shaped clip as shown in the illustrations. Using this U-shape has the benefit that two parts can be gripped and attached to each other. It can be envisaged that the parts are arranged above each other or, seen from the longwise direction of a clip, behind each other, within a U-shaped indentation formed by the jaws of the clip.

In another embodiment of the shelving system it is intended that the units can be stacked on top of each other and the side-walls which are lying on top of each other or alongside each other are linked together using an H-shaped second type of clip. It is preferable for the units also to have aids for stacking, for example interlocking pegs and corresponding indentations, by means of which the U-shaped space dividers can be stacked on top of each other. The corresponding stacking aid devices can be sited on the upper side of the lever arm and on the underside of the partial bases, where the lower side of the partial bases are stackable onto the upper side of the lever arms. It is beneficial to envisage that between each underside of a partial base and the upper side of a lever arm at least one H-shaped clip is present, which with its U-shaped side, similar to the U-shaped clips described above, grips the lever arm and with its U-shaped side opposite grips an indentation or a slot in the partial base. This provides the advantage of being able to fasten space dividers which are stacked on top of each other.

A further embodiment of the shelving system provides for a second type of clip whose first side is the same in form and function as the first type of clip and which through a second side of the second type of clip a stacked neighboring side wall can be gripped. Preferably the second type of clip can be used to create a link which corresponds to the first type of clip between two matching units which create a U-shaped space divider. Using the opposite side has the benefit that an attachment to a space divider, ideally of identical construction, stacked beneath it can be achieved.

A further embodiment of the shelf system provides for the units being able to be placed alongside each other and with the side walls of multiple units lying parallel to each other, each attached to each other using one or two U-shaped clips of a third type. The benefit of these U-shaped third type of clips is that they can be used to attach or to fix two side walls which are laid next to each other or which abut each other. This has the benefit that it makes it possible to attach to each other or to fix together any number of U-shaped space dividers, each made up of two of the units. This has the benefit that the shelving system cannot only be built upwards by stacking the individual U-shaped dividers, but can also be extended sideways as far as wished.

A further embodiment of the shelving system is provided, where the first side and the second side of an H-shaped fourth type of clip each correspond to the third type of clip in shape and function, and by using this fourth clip a total of four sidewalls of a multiplicity of units can be attached together. This has the benefit that using the fourth type of clip both space dividers which are laid alongside each other and those which are stacked on top of each other can be attached or fixed together.

Another embodiment of the shelving system is shown, where the first side of an H-shaped fifth type of clip corresponds to the first type of clip in form and function and the second side of the fifth type of clip corresponds to the third type of clip in form and function, and by using this fifth type of clip a total of three side walls of the series of units can be combined together. This has the benefit that by using the fifth type of clip the shelving system can be constructed in an extremely flexible way. It is possible, for example, to have two U-shaped space dividers next to each other, combined with a third U-shaped space divider stacked on top of them.

A further example of a preferred embodiment of the shelving system is where the lever arm of a first unit can be combined with the partial base of a second unit, and the lever arm of a second unit can be combined with the partial base of a first unit and depending on the neighboring arrangement further units of many may use the first type of clip, the second type of clip, the third type of clip, the fourth type of clip and/or the fifth type of clip. The benefit is that all clips are built in form and function in such a way that the combination of two of the units into a U-shaped space divider can be further stabilized, or alternatively the two units can be fixed to each other. Depending on the configuration of the clips these, as described above, are designed such that they combine further U-shaped space dividers, each consisting of two units, for example when these are aligned next to each other or stacked above each other.

This has the benefit that the smallest elements of the shelving system, the units, are constructed identically in shape, function and materials, and for example can be manufactured using injection molding. A further benefit is the option of stacking individual units inside each other, for example for transport or storage. In addition the units can be L-shaped and can then be fitted together appropriately. Another possible benefit would be the ability to provide aids to stacking, such as prongs or pegs and matching indentations on the upper surface and underside of the partial bases or other appropriate surface areas. When stacked, the partial bases and also the lever arms can then interlock.

Further benefits, features and characteristics of the invention can be understood from the following description, in which various embodiments are described in detail, referring to the drawing. Identical, functionally identical or similar parts are shown with the same reference number.

### FIGURES

FIG. 1 shows a plan view of two units used to create a space divider;

FIG. 2 shows a side view of each of the two units shown in FIG. 1;

FIG. 3 shows a plan view of two further units used to create a space divider;

FIG. 4 shows a side view of each of the two units shown in FIG. 3;

FIG. 5 shows a plan view of two U-shaped space dividers, which are connected using two U-shaped clips;

FIG. 6 shows a side view of a U-shaped space divider with two units similar to the images in 1-4, but where the units additionally are joined using two U-shaped clips;

FIG. 7 shows, like FIG. 3, a detailed view of a partial base of a unit to be used to create a space divider together with a side wall of a further unit to be used to create a space divider from below and not yet joined, each with a snap-in locking device, representing the detail of the area which is indicated in FIG. 3 with a dotted circle;

FIG. 8 shows the detail shown in FIG. 7, where the snap-in locking device also has sloping sides as a guide mechanism to make it easier to insert a clip;

FIGS. 9a/9b each show the detail of the units shown in FIG. 7, but once joined together,

and in FIG. 9b additionally joined using a U-shaped clip;

FIGS. 10a/b each show detailed views similar to FIGS. 9a and 9b, where in each case the details of a total of four units are shown from below, which are combined to create two U-shaped space dividers; in FIG. 10b these are additionally joined by means of a U-shaped clip;

FIG. 11 shows a side view of two U-shaped space dividers similar to the presentation in FIG. 6, which are stacked above each other and joined using H-shaped clips;

FIG. 12 shows a detail of the view from below of a unit similar to the unit shown in FIG. 3 used to create a space divider with a snap-in locking device, representing the detail of the area which is indicated in FIG. 3 with a dotted square;

FIG. 13 shows a side view of the details shown in FIG. 12;

FIGS. 14a-d show various views and embodiments of a U-shaped clip;

FIGS. 15a/b show various views of another U-shaped clip;

FIGS. 16a-c show various views of an H-shaped clip;

FIGS. 17a-c show various views of another U-shaped clip;

FIGS. 18a-c show various views of another H-shaped clip; and

FIGS. 19a-c show various views of another H-shaped clip with a step.

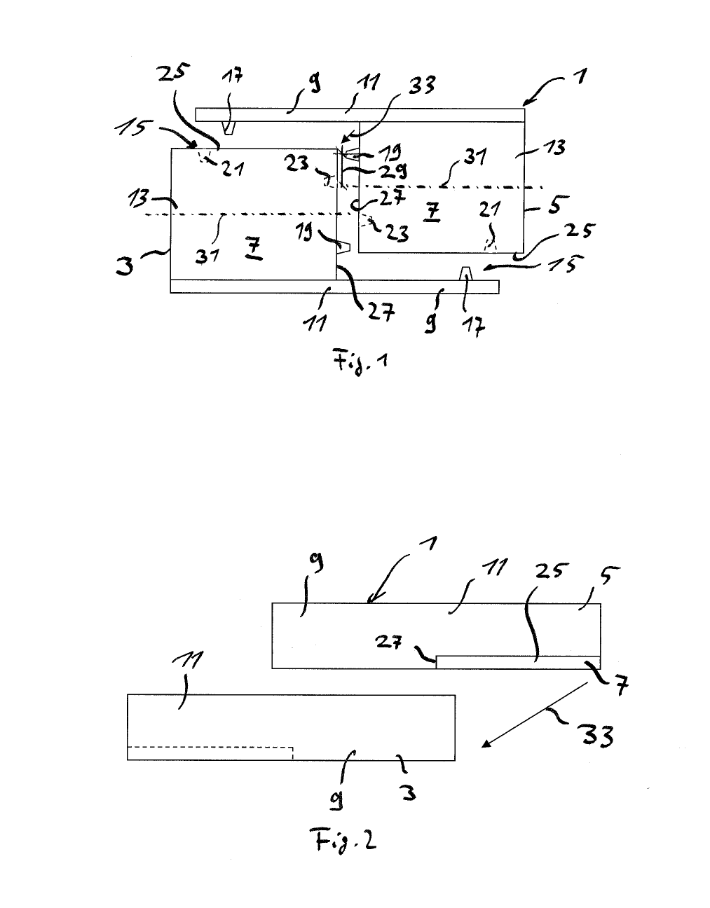

FIG. 1 shows an exploded view of a space divider 1 with a first unit 3 and a second unit 5, which can be combined to create the divider 1. Units 3 and 5 are ideally identically constructed, and each includes a partial base 7 and has a lever arm 9 attached to the partial base 7, which appears as a side wall standing perpendicular to the partial base 7. When combined, the divider 1 has a U-shaped cross-section. It can be seen that the sidewall 11 in each case is twice as long as the partial base 7, which has the benefit that a continuous U-shaped cross-section can be formed, on the one hand, from the two partial bases 7 making up the total base 13, as well as the two sidewalls 11. A possible alternative is that units 3 and 5, which can be combined to form divider 1, have partial bases 7 of different sizes, with areas for example in the ratio of 1/3rd to 2/3rd. In this case the side wall 11 would still have the same length, with the sole difference that the actual lengths of the lever arms 9 are different. Irrespective of this, the side walls 11 are of equal length to the total base 13 made up from combined partial bases 7.

The partial bases 7 and the lever arm 9, and in particular the side wall 11, when combined as divider 1, include a fixing device 15, by means of which units 3 and 5 can be joined together. Ideally this will allow sufficient adhesive force to be applied such that space divider 1 will not spontaneously disassemble when handled, for example if picked up using just one side wall 11 or, for example, just one of units 3 or 5. As part of fixing device 15, each of units 3 and 5 include a first pin 17 and a second pin 19. Pins 17 and 19 can be used to attach units 3 and 5 by being inserted in a first indentation 21 and a second indentation 23. Each of units 3 and 5 therefore includes a first indentation 21 and a second indentation 23. Wherever in the following reference is made to a partial base 7, lever arm 9 and/or a side wall 11, the description applies equally to the first unit 3 and the second unit 5, as these are identical in respect of the fixing device 15.

The first pin 17 is attached to the lever arm 9. The first indentation 21 is assigned to a side 25 of the partial base 7 or set into side 25. When fixed together the first pin 17 of the side wall 11 can be inserted into the first indentation 21 of the side 25 of the partial base 7 thus applying interlocking forms, friction and/or traction.

A side wall 27 of partial base 7 includes the second pin 19 as well as the second indentation 23. The side walls 27 can, when joined in the divider 1, be attached to each other using the fixing device 15 by means of interlocking forms, friction and/or traction. In addition, the second pin 19 can slot into the second indentation 23 on the side wall 27 of units 3 and 5. Pins 19 and indentations 23 are shown as examples, and could be replaced or complemented by any other preferred linking element using interlocking forms, friction and/or traction, for example roughening the surface, a surface structure, particularly a zig-zag structure, one or more steps and/or similar.

To form the fixing device 15, the second pin 19 is an identical distance 29 from the central axis 31 of the partial base 7. In order to ensure that the second pin 19 of the first unit 3 will insert into the second indentation 23 of the second unit 5, a male shape or a surface of the second pin 19 and female shape or surface of the second indentation 23 are basically 180° rotationally symmetrical to an axis—not shown in FIG. 1—which is perpendicular to the plane of the image and which transects mid-axis 31 and runs through the side wall 27 of partial base 7. To achieve fixing using interlocking forms, friction and/or traction it is also possible that the second pin 19 and the second indentation 23 are deliberately minutely offset from the 180° rotational symmetry, which causes the necessary fitting force to occur when the parts are joined. Fundamentally, in order to achieve the alignment of side walls 27 of units 3 and 5 to each other using interlocking forms, friction and/or traction, any rotationally symmetrical shapes on side wall 27 can be envisaged, with a male structure, plus a female structure which is rotationally symmetric to it on the above mentioned rotational axis, into which the male structure can be inserted. It is possible when creating the joints here to envisage elasto-mechanical undercuts which can be forced and provide a snap-in locking function. Further, it is possible to slightly offset the female structure from exact rotational symmetry to the male structure and thereby allow some play. What is important is that the male structure is inserted into the female structure and engages using interlocking forms, friction and/or traction or at least can be adjusted to fit.

FIG. 2 shows a side view of each of the first unit 3 and the second unit 5 from FIG. 1. An arrow 33 indicates how units 3 and 5 can be combined into divider 1. It can be seen that the partial base 7 is flush with the side wall 11, so is placed alongside the side wall 11.

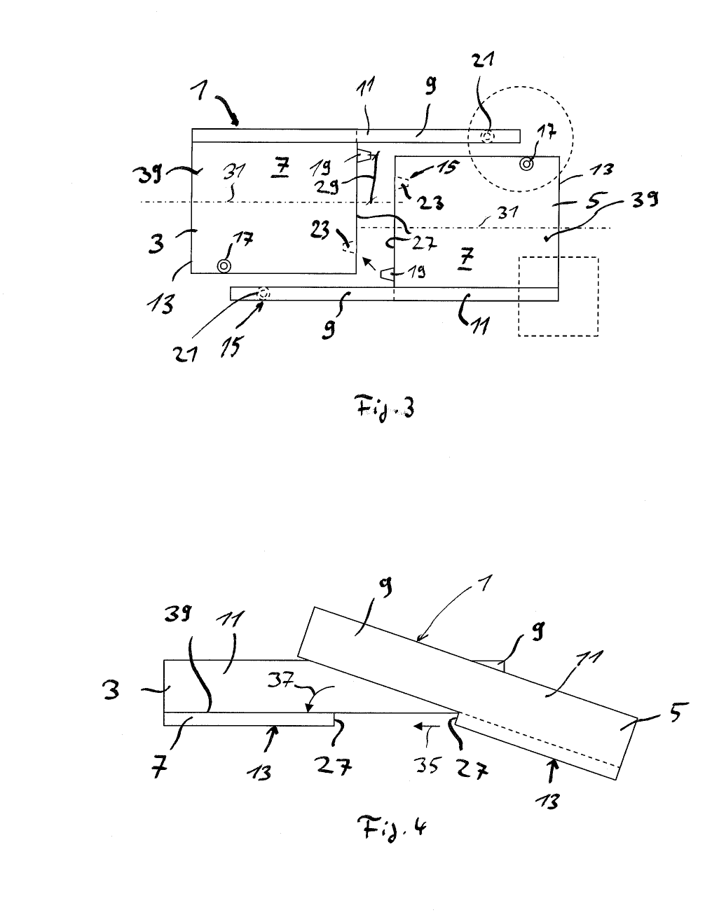

FIG. 3 shows a space divider 1 with a first unit 3 and a second unit 5, similar to FIG. 1. FIG. 4 shows the divider shown in FIG. 3 in a side view similar to the presentation in FIG. 2. Only the differences are discussed below. Unlike what is shown in FIGS. 1 and 2, the partial base 7 is placed under the side wall 11 which is shown in FIG. 4 as a visible step. Similarly, units 3 and 5 can be combined in a plurality of ways as shown in FIGS. 1 and 2 or as in FIGS. 3 and 4 to create divider 1. As shown in FIGS. 1 and 2, units 3 and 5 can be slid together in a sliding motion as shown in FIG. 1 by the arrow 33 and snapped into each other using fixing device 15. For this purpose the arm lever 9 can, for example, bend slightly outwards before it snaps into place against the corresponding side wall 11 of the other unit 3 or 5. According to diagrams 3 and 4, units 3 and 5 can first be brought together at an angle and slid together sideways, which is indicated by arrow 35. The fronts 27 of units 3 and 5 can then move together either until they touch, or until the second pins 19 catch on the second indentations 23. FIG. 4 indicates using a curved arrow 37 that, from the position where they have originally caught, the lever arm 9 or the front wall 11 can be swung around the front 27 towards the partial base 7 until the first pins 17 snap into the relevant indentations 21 in units 3 and 5.

A further difference is the first pin 17 shown in FIG. 3 on the visible inside 39 of the partial base 7. Accordingly the first indentation 21, into which the first pin 17 can fit using interlocking forms, friction and/or traction, is present on the underside 41 of the lever arm 9 or the side wall 11, which are not visible in FIG. 3.

To simplify, in FIGS. 2 and 4, the pins 17 and 19 and the indentations 21 and 23 are not shown in detail. Alternatively and/or additionally it is possible to have a pin and an indentation on the inside 39, and provide another pin and an indentation on the underside 41 to match these. It is also possible to have a protrusion on the lever arm 9, which is not shown, basically perpendicular to the underside 41, which fits into a corresponding step or indentation which is basically also perpendicular to the inner side 39. This has the benefit that the lever arm 9 can be tensioned using the twisting movement shown by the third arrow 37, so that the front 27 of the partial base 7 of both units 3 and 5 are held together under tension. A benefit is that by using the fixing device 15 and the interlocking forms, and the friction and/or traction thereby provided to attach the front 27, this part can be prevented from slipping out of place. By pre-tensioning and using the interlocking forms, friction and/or traction attachment of the fronts 27 to each other, a particularly stable configuration can be achieved which combines units 3 and 5 together, and therefore creates a stable space divider 1.

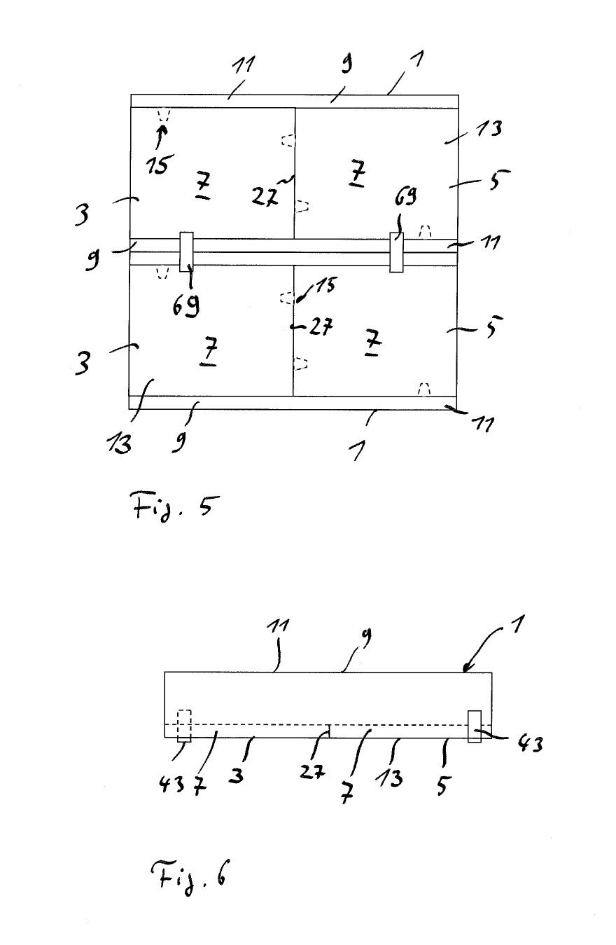

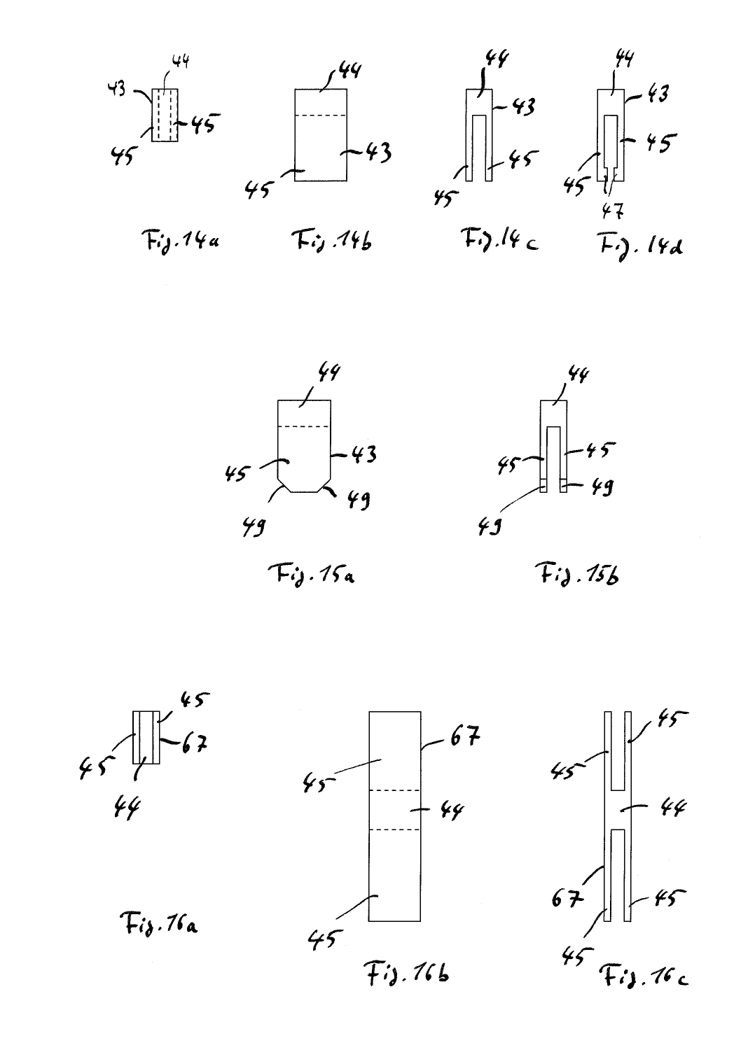

FIG. 6 shows a side view of the divider 1 shown in FIGS. 1 and 2 or 3 and 4. In addition two U-shaped first type clips 43 can be seen, by means of which the partial bases 7 are also attached to the lever arms 9 or the side walls 11 of units 3 and 5. FIGS. 14a to 14c show various views of the U-shaped first type of clip 43. FIG. 14a shows a view from below, FIG. 14b a side view and FIG. 14c a further side view of the U-shaped first type of clip 43. The U-shaped first type of clip 43 includes a connecting crosspiece 44 to which the two legs, 45 are attached. The U-shaped first type of clip 43 may for example be cast in one piece by injection molding. The two legs 45 can also be used as snap-in locking arms and can show a certain degree of elasticity.

FIG. 14d shows a further U-shaped first type clip 43 from a side view, similar to FIG. 14c. The difference being that the legs 45 each show a locking lug 47 that protrudes inwards. The locking lugs 47 can be inserted into the snap-in locking indentation in the side walls 11—not shown in detail in FIG. 6—in order to add locking force to the clamping force holding the side walls 11 against the neighboring partial bases 7.

FIGS. 15a and 15b show a further U-shaped first type clip 43 as in the diagrams shown in FIGS. 14b and 14c. In contrast, the front ends of the legs 45 show insert diagonal edges 49, for example at an angle of 45°. The benefit is that the further U-shaped first type of clip 43 as shown in FIGS. 15a and 15b can be inserted more easily into the indentations to create a snap-in locking connection.

FIG. 7 shows the detail of a view from below of the area of the space divider 1 shown in FIG. 3 and delimited by means of a dotted circle in FIG. 3. In contrast to the image in FIG. 3, the partial base 7 of the second unit 5 has a rectangular slot 51 and a rectangular notch 53. The legs 45 of the U-shaped first type of clip 43 are inserted through or into the slot 51 and the notch 53 of the partial base 7. Equally, in contrast to what is shown in FIG. 3, the side wall 11 of the first unit 3 has an internal notch 55 and an external notch 57 where the external notch 57 matches the dimensions of notch 53 of the partial base 7, and the internal notch 55 matches the dimensions of slot 51 of the partial base 7. This means that the legs 45 of the U-shaped first type of clip 43 can be inserted into the inner notch 55 and the outer notch 57. It can be envisaged that the internal notch 55 and the external notch 57 could include snap-in locking indentations, which are not shown in FIG. 7 in detail, into which the locking lugs 47 of the U-shaped first type of clip 43 shown in FIG. 14d could be inserted. In line with the view from below in FIG. 7, the partial base 7 can be aligned with the side wall 11 in such a way that, as shown in FIG. 7, the partial base 7 is positioned in front of the side wall 11.

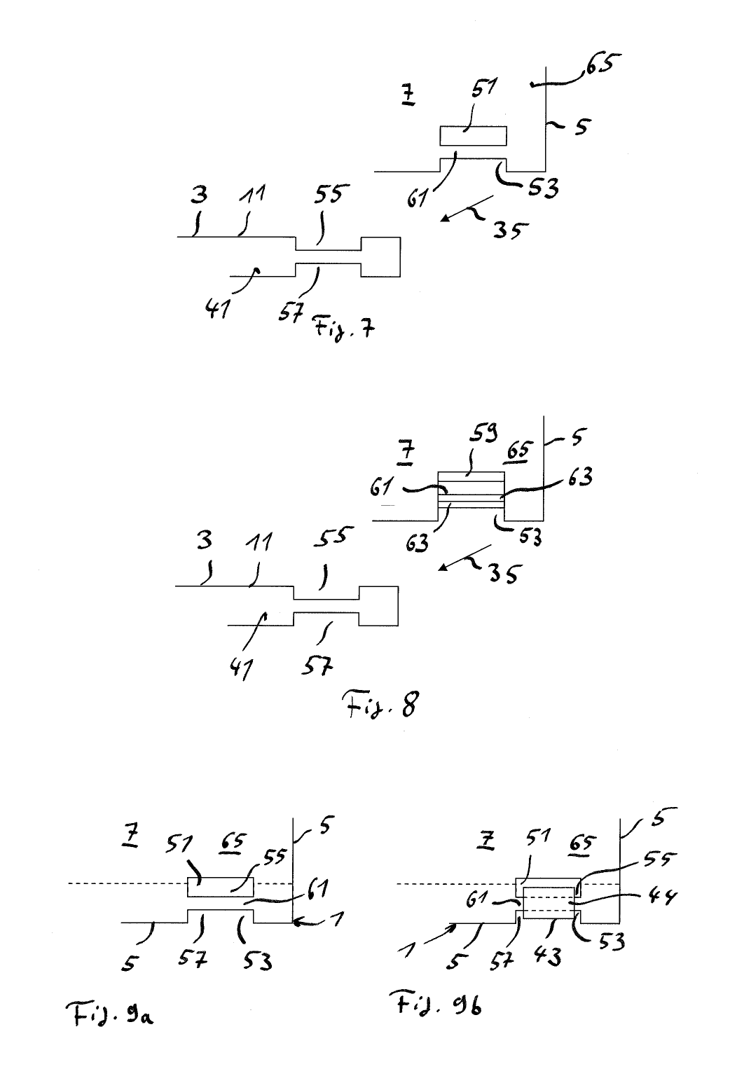

This combined situation is shown in FIG. 9a, in which the side wall 11 of the first unit 3 which is beneath the partial base 7 of unit 5 is shown using dotted lines.

FIG. 9b shows units 3 and 5 from below, as does FIG. 9a, but with the addition of the U-shaped first type of clip 43. It can be seen that the legs 45 of the U-shaped first type of clip 43 are inserted through the slot 51 into the inner notch 55, as well as into notch 53 of the partial base 7, as well as into the outer notch 57 of side wall 11. In the diagram in FIG. 9b the crosspiece 44 is in front of the partial base 7, and the partial base 7 is in front of either the side wall 11 or the lever arm 9.

FIG. 8 shows the side wall 11 of the first unit 3 and the partial base 7 of the second unit 5 from below as in FIG. 7, but in a more extensive embodiment. Only the differences to FIG. 7 are discussed below. In contrast to the presentation in FIG. 7, slot 51 shows a chamfer 59. By means of the chamfer 59, the leg 45 of the U-shaped first type of clip 43 can be inserted to assist in forming a locking connection of the partial base 7 to the side wall 11. In addition, a strip 61 remaining between the slot 51 and the notch 53 of the partial base 7, displays two chamfers 63, which can also act as guides for the insertion of the legs 45 of the U-shaped first type of clip 43. A further difference it that the strip 61 is set back in relation to the underside 65 of partial base 7. It is beneficial if the strip 61 can be set back far enough that the crosspiece 44 of the U-shaped first type of clip 43 lies flush with the underside 65 of the partial base 7. In contrast to the depiction in FIG. 6, this has the benefit that the U-shaped first clip 43 does not protrude beyond the underside 65 of the partial base 7. This means that the divider 1 now created can be set down on a supporting area, such as the floor, on the underside 65 of the partial base 7.

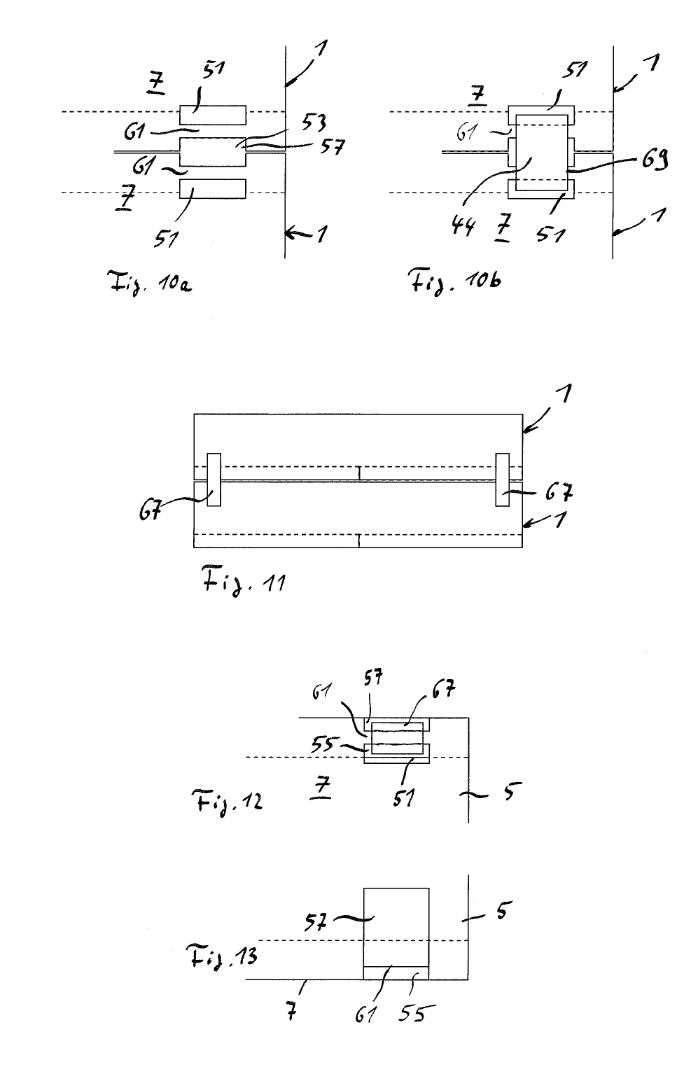

FIG. 11 shows a side view of two of the dividers 1 similar to FIGS. 1 and 2 or 3 and 4. The dividers 1 in FIG. 11 are shown stacked on top of each other and linked using an H-shaped second type of clip. The H-shaped second type of clip 67 grips the side wall 11 from above and a partial base 7 as well as a side wall 11 positioned above it, similar in form and function to the diagram in FIG. 9b.

The H-shaped second type of clip 67 is shown from various views in FIGS. 16a to 16c. FIG. 16a shows the H-shaped second type of clip 67 from below, FIG. 16b shows a side view and FIG. 16c a further side view. It can be seen that the H-shaped second clip 67 has a total of four legs 45, which are shaped like the legs 45 of the U-shaped first type of clip 43 shown in FIGS. 14a to 14c. The total of four legs 45 are arranged facing a crosspiece 44, such that the H-shaped second type of clip 67 basically provides the functionality of the U-shaped first type of clip 43 twice over.

FIG. 5 shows a top view of two dividers 1 side by side, built similarly to FIGS. 1 and 2 or 3 and 4. It can be seen that the side walls 11 of the two dividers 1 are set either parallel to or next to each other. To fix the side walls 11 which are set next to or parallel to each other and so fix the two dividers 1 shown in FIG. 5, two U-shaped third type of clips 69 are used, which grip two side walls 11. The U-shaped third type of clip 69 is also significantly wider than the U-shaped first type of clip 43, in order to be able to grip two side walls 11. This has the benefit that two side walls 11 can be joined together or fixed to each other.

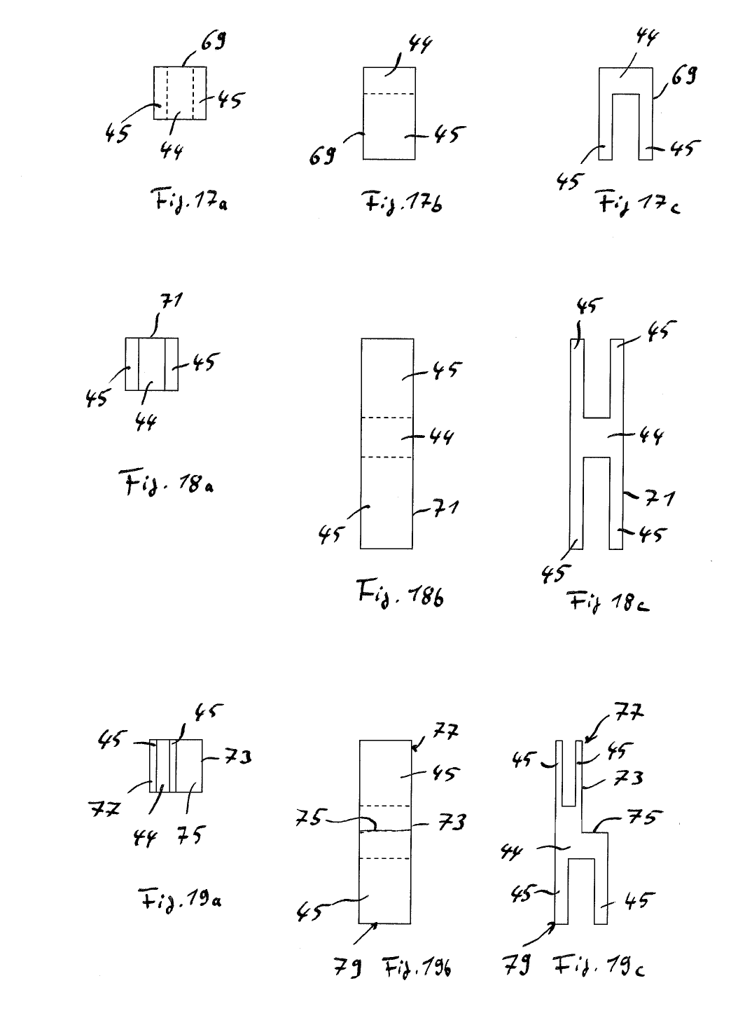

FIGS. 17a to 17c show different views of the U-shaped third type of clip 69. FIG. 17a shows a view from below, FIG. 17b a side view and FIG. 17c a further side view of the U-shaped third type of clip 69. In form and function the U-shaped third type of clip 69 is basically analogous to the U-shaped first type of clip 43 shown in FIGS. 14a to 15b. In contrast, the U-shaped third type of clip 69 is wide enough to be able to grip two side walls 11 and join them together.

FIGS. 18a to 18c show different views of the H-shaped fourth type of clip 71. FIG. 18a shows a view from below, FIG. 18b a side view and FIG. 18c a further side view of the H-shaped fourth type of clips 71. The H-shaped fourth type of clip 71 is analogous in form and function to the H-shaped second type of clip 67, except that it is wide enough to be able to grip two side walls 11. Both the open ends of the H-shaped fourth type of clip 71 are identical in form and function to the U-shaped third type of clip 69. The benefit here is that by using the H-shaped fourth type of clip 71 it is possible to join dividers 1 which are stacked on top of each other, as shown in FIG. 11, and next to each other, as shown in FIG. 5.

FIGS. 19a to 19c show different views of the H-shaped fifth type of clip 73 with a step 75. FIG. 19a shows a top view of the step 75, FIG. 19b a side view and FIG. 19c a further side view. The H-shaped fifth type of clip 73 shows on its upper end 77 fundamentally similar functionality to the U-shaped first type of clip 43 shown in FIGS. 14a to 15b, and on its lower end 79 basically the functionality of the U-shaped third type of clip 69, as shown in FIGS. 17a to 17c. The step 75 is used to join together the top end 77 and the bottom end 79. This has for example the benefit that by using these H-shaped fifth type of clips 73, three of the dividers 1 can be joined together. This, for example, makes it possible to have two of the dividers 1 alongside each other, as shown in FIG. 5 and to connect these together using the lower part 79 of the fifth type of clip 73. A further divider 1 can then be stacked on top of these two dividers, as shown in FIG. 11, with the benefit that, using the H-shaped fifth clip 73, the divider 1 stacked on top can be attached to the other two dividers 1, while a matching partial base 7 can be attached to the side wall 11 of the divider 1 on top of it.

FIGS. 10a and 10b show a detail of a view from below of dividers 1 arranged next to each other as shown in FIG. 5. It can be seen that the U-shaped third type of clip 69 is inserted into the slots 51 of the dividers 1. The U-shaped third clip 69 therefore is only inserted from inside into the slot 51 in order to attach the side walls 11. The outer notch 57 is not made use of for this function.

FIGS. 12 and 13 show a further property of units 3 and 5. FIG. 12 shows a view from below of a detail of a snap-in locking device 81, whose position is indicated in the right-hand corner of FIG. 3 by a dotted square. FIG. 13 shows a side view of the side wall 11 of the second unit 5. It can be seen that in this area too, the side wall 11 has an outer notch 57 and an inner notch 55, into which the legs 45 of, for example the H-shaped second type of clip 67 can be inserted. In line with this there is also a first slot 51. In contrast to what is shown in FIG. 9b the side wall 11 of the first unit 3 is joined integrally at this point to the partial base 7. Otherwise the snap-in locking device 81 provides the same functionality as shown in FIG. 9b. Therefore we refer for this to the description of FIGS. 9a and 9b. A further difference to FIG. 13 can be seen, in that the outer notch 57 is not cut right through the depth. Alternatively, that would be possible.

Details of various Figures, in particular those relating to the clips or snap-in locking devices, can be combined to create further embodiments. For example, pins 17, 19 and indentations 21, 23 or insert diagonal edges 49 or chamfers 59, 63 can be added at various places, even where these have not been illustrated explicitly.

Key to reference numbers

| | |
|---|---|
| 1 | divider |
| 3 | first unit |
| 5 | second unit |
| 7 | partial base |
| 9 | lever arm |
| 11 | side wall |
| 13 | overall base |
| 15 | fixing device |
| 17 | first pin |
| 19 | second pin |
| 21 | first indentation |
| 23 | second indentation |
| 25 | side |
| 27 | front |
| 29 | distance apart |
| 31 | central axis |
| 33 | arrow |
| 35 | arrow |
| 37 | arrow |
| 39 | inside |
| 41 | underside |
| 43 | first clip |
| 44 | crosspiece (of clip) |
| 45 | leg (of clip) |
| 47 | locking lug |
| 49 | insert diagonal edges |
| 51 | slot |
| 53 | notch |
| 55 | internal notch |
| 57 | external notch |
| 59 | chamfer |
| 61 | strip |
| 63 | phases |
| 65 | underside |
| 67 | second clip |
| 69 | third clip |
| 71 | fourth clip |
| 73 | fifth clip |
| 75 | step |
| 77 | top |
| 79 | underside |
| 81 | snap-in locking device |

What is claimed is:

1. A device comprising a unit to create a space divider, comprising:
a partial base to create the space divider and
a lever arm attached to the partial base,
wherein two of the said units are combined into a single combined base, on a single level by using two partial bases, the lever arms of the units being attachable to the partial base of the other unit using an attachment device created by the lever arm and the partial base themselves and the two partial bases of the two units can be linked together by means of at least one of the following elements: interlocking forms, friction and traction.

2. The device of claim 1, further comprising wherein the lever arm constitutes a side wall perpendicular to the partial base in order to create the divider.

3. A shelving system comprised of a plurality the devices of claim 1 and a plurality of clips to link the units together.

4. The shelving system of claim 3, further comprising wherein a lever arm of a first unit of many is linked to the partial base of a second unit, and the lever arm of a second unit of many is linked to the partial base of the first unit of many, using the first type of U-shaped clip.

5. The shelving system of claim 3, further comprising wherein the units can be stacked on top of each other and the side-walls which are lying on top of and alongside each other can be linked together using an H-shaped second type of clip.

6. The shelving system of claim 3, further comprising wherein the first side of the second type of clip corresponds to the first type of clip in form and function and where the second side of the second type of clip is used to grip a side wall which is stacked alongside.

7. The shelf shelving system of claim 3, further comprising wherein the units can be placed alongside each other and where the side walls of multiple units lying parallel and next to each other, can each be attached to the others using one or two U-shaped clips of a third type.

8. The shelving system of claim 3, further comprising wherein the first side and the second side of an H-shaped fourth type of clip each correspond to the third type of clip in shape and function, and the fourth type of clip is used to attach a total of four sidewalls of a multiplicity of units.

9. The shelving system of claim 3, further comprising wherein the first side of an H-shaped fifth type of clip corresponds to the first type of clip in form and function, and the second side of the fifth type of clip corresponds to the third type of clip in form and function, and the fifth type of clip is used to attach a total of three side walls of the series of units.

10. The shelving system of claim 9, further comprising wherein the lever arm of the first unit (3) of many can be combined with the partial base of the second unit, and the lever arm of the second unit of many can be combined with the partial base of the first unit of many and, depending on the neighboring arrangement of further units, may be attached using the first type of clip, the second type of clip, the third type of clip, the fourth type of clip or the fifth type of clip.
